(19) United States
(12) Patent Application Publication
(10) Pub. No.: US 2013/0186795 A1
(43) Pub. Date: Jul. 25, 2013

(54) Tray Case

(71) Applicant: Scott Borrelli, Poulsbo, WA (US)

(72) Inventor: Scott Borrelli, Poulsbo, WA (US)

(21) Appl. No.: 13/739,040

(22) Filed: Jan. 11, 2013

Related U.S. Application Data
(60) Provisional application No. 61/589,444, filed on Jan. 23, 2012.

(51) Int. Cl. B25H 3/02

(52) U.S. Cl. CPC B25H 3/021
USPC 206/373

(57) ABSTRACT

A multifunctional tray case is disclosed which resembles a briefcase for tools, lights, power cords, and other smaller items, and can be used where a level and secure surface is not available and/or lighting is limited. The multifunctional tray case comprises a rectangular box-like structure comprised of first and second complimentary halves, and a hinge which pivotally secures the first and second complimentary halves together. The multifunctional tray case further comprises a handle for transportation of the case and at least one power outlet and/or light socket positioned near the back of the case. The multifunctional tray case further comprises a main compartment removably secured to an interior of the first complimentary half which comprises a large central tray and/or segmented trays, and a fold-open cover. Furthermore, the multifunctional tray case comprises movable legs secured to the corners of the second complimentary half.

### CROSS-REFERENCE

This application claims priority from Provisional Patent Application Ser. No. 61/589,444 filed Jan. 23, 2012.

### BACKGROUND

Auto mechanics and others constantly seek areas under the hood of a car or other vehicle to place tools, hardware and auto components, etc., which often times end up misplaced or dropped into inaccessible areas around the engine compartment and other hard to reach places. This can lead to wasted time, frustration and the extra expense spent retrieving the item or replacing it entirely. Further, artisans of all professions must carry around many and various tools, but do not always have an organized way to carry the tools and/or a level surface on which to keep the tools during use. Additionally, if there is not adequate light available, individuals are unable to access their tools effectively or perform their work. A convenient and effective solution to all of the forgoing is necessary.

There is a need for a multifunctional tray case that allows home and professional mechanics and hobbyists to always maintain storage and placement of a tray, while also having access to power and light as needed. The present invention would also be useful for business documentation/presentation situations, campers, laptops, traveling repairs, or virtually any situation where an uneven work or play area requires a level table top or array of trays with electrical or battery power. The multifunctional tray case may help a mechanic or other professional perform his or her job more efficiently and effectively, eliminating the hassle and frustration of inconvenient access to tool boxes. Campers, writers, artists, and business people, etc., would also appreciate the ability to customize the multifunctional tray case to carry tools of their respective trades while offering unparalleled organization and portability. Anyone who uses this invention would benefit from the convenience and organization this multifunctional tray case provides.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a multifunctional tray case which resembles a briefcase for tools, lights, power cords, and other smaller items, and can be used where a level and secure surface is not available and/or lighting is limited. The multifunctional tray case comprises a rectangular box-like structure comprised of first and second complimentary halves, and a hinge which pivotally secures the first and second complimentary halves together. The hinge allows the first and second complimentary halves to pivot from a closed position, approximately 180 degrees to an open position. The multifunctional tray case further comprises a handle positioned opposite of the hinge, to allow a user to transport the multifunctional tray case easily and efficiently. Additionally, the multifunctional tray case comprises at least one power outlet and/or light socket positioned near the back of the multifunctional tray case.

In a preferred embodiment, the multifunctional tray case further comprises a main compartment removably secured to an interior of the first complimentary half. The main compartment comprises a large central tray which may also comprise at least one segmented tray and/or other dividers formed therein. The main compartment also comprises a fold-open cover and side compartments for additional storage. Furthermore, the multifunctional tray case comprises movable legs secured to the corners of the second complimentary half The movable legs are typically three joint leg assemblies that are stored within the interior of the second complimentary half when not in use and folded down from the corners of the second complimentary half when in use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a front perspective view of the multifunctional tray case in accordance with the disclosed architecture.

FIG. 2 illustrates a side perspective view of the multifunctional tray case in accordance with the disclosed architecture.

FIG. 3A illustrates a top perspective view of the multifunctional tray case pivoted in an open position in accordance with the disclosed architecture.

FIG. 3B illustrates a top perspective view of the multifunctional tray case wherein the main compartment and side compartments are open in accordance with the disclosed architecture.

FIGS. 4A-B illustrate a perspective view of the multifunctional tray case in use with a vehicle in accordance with the disclosed architecture.

FIG. 5A illustrates a perspective view of the multifunctional tray case in use as a work desk in accordance with the disclosed architecture.

FIG. 5B illustrates a perspective view of the multifunctional tray case in use as a work tool supported against a ladder in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a multifunctional tray case that allows home and professional mechanics and hobbyists to maintain storage and placement of a tray, while also having access to power and light as needed. The case would be useful for virtually any situation where an uneven work or play area requires a level table top or array of trays with electrical or battery power. The multifunctional tray case eliminates the hassle and frustration of inconvenient access to tool boxes, and allows users to customize the multifunctional tray case to carry tools of their respective trades while offering unparalleled organization and portability.

The multifunctional tray case comprises a generally rectangular box-like structure comprised of first and second complimentary halves, and a hinge which pivotally secures the first and second complimentary halves together. The multifunctional tray case further comprises a handle for transportation of the case and at least one power outlet and/or light socket positioned near the back of the case. The multifunctional tray case further comprises a main compartment removably secured to an interior of the first complimentary half which comprises a large central tray and/or segmented trays, and a fold-open cover. Furthermore, the multifunctional tray case comprises movable legs secured to the corners of the second complimentary half.

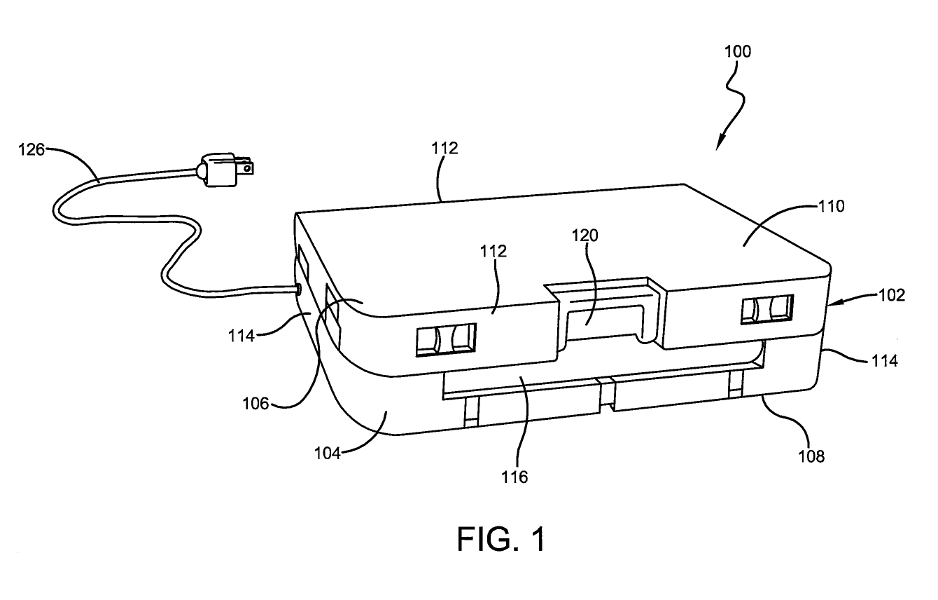

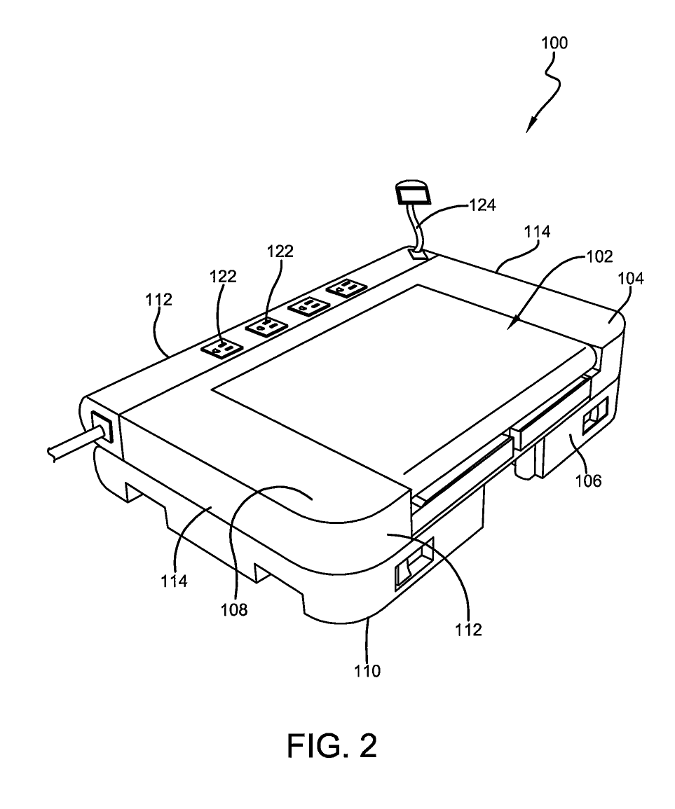

Referring initially to the drawings, FIGS. 1-2 illustrate the multifunctional tray case 100 which resembles a briefcase for tools, lights, power cords, and other smaller items, and can be used where a level and secure surface is not available and/or lighting is limited. The multifunctional tray case 100 comprises a rectangular box-like structure 102 comprised of first 104 and second 106 complimentary halves, each half 104 and 106 comprising a top surface 108 and a bottom surface 110, a pair of end walls 112, and a pair of side panels 114. Typically, the box-like structure 102 is rectangular in shape, however any other suitable shape can be used as is known in the art without affecting the overall concept of the invention.

The box-like structure 102 would generally be constructed of aluminum, steel, magnesium, or a composite plastic, etc., though any other suitable material may be used to manufacture the box-like structure 102 as is known in the art without affecting the overall concept of the invention. The box-like structure 102 can also comprise a variety of colors and designs to suit user preference. The box-like structure 102 is approximately between 16 and 20 inches long as measured from opposing side panels 114, and approximately between 14 and 16 inches wide as measured from opposing end walls 112, and approximately between 4 and 6 inches high as measured from the bottom surface 110 of the second complimentary half 106 to the top surface 108 of the first complimentary half 104 of the box-like structure 102. Typically, the pair of end walls 112 and the pair of side panels 114 are substantially identical in height, but do not have to be and the multifunctional tray case 100 can function without the end walls 112 and the side panels 114 being identical in height.

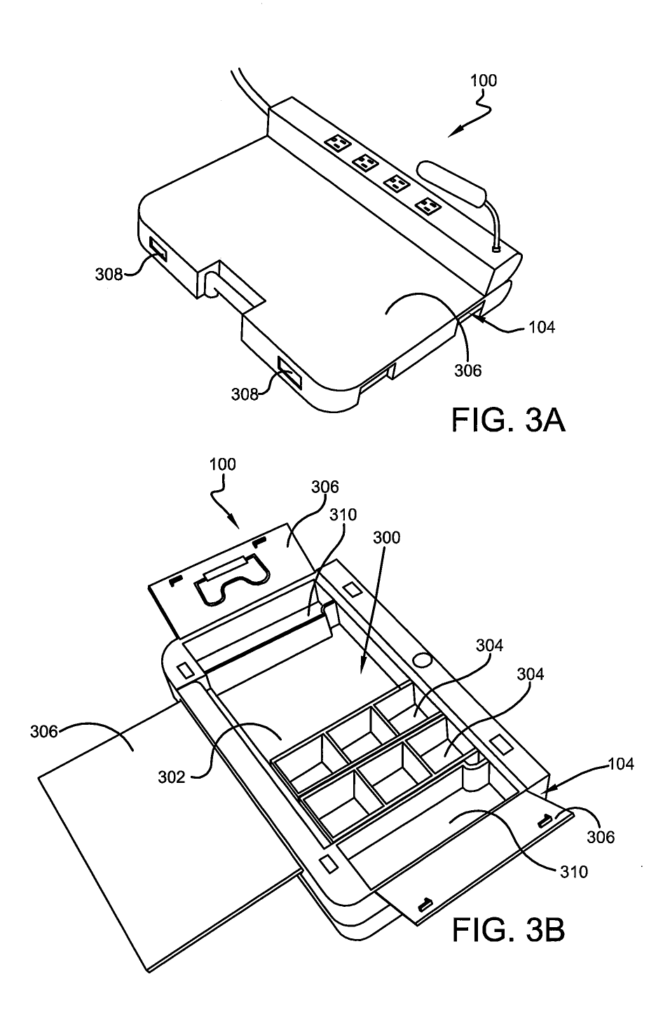

The multifunctional tray case 100 further comprises at least one hinge 116 or other joint which pivotally secures the first 104 and second 106 complimentary halves together at one of the pair of end walls 112. In a preferred embodiment, the multifunctional tray case 100 comprises two hinges 116. The hinges 116 allows the first 104 and second 106 complimentary halves to pivot from a closed position (shown in FIGS. 1-2), approximately 180 degrees to an open position (shown in FIGS. 3A-B). In the open position, the top surface 108 of the first complimentary half 104 contacts the bottom surface 110 of the second complimentary half 106. Thus, the hinge 116 may be a double pivot assembly which allows each complimentary half 104 and 106 to completely invert upon itself from the closed position.

The multifunctional tray case 100 further comprises a handle (not shown) positioned opposite of the hinge 116. The handle can be any standard handle as is known in the art and functions as a typical prior art handle to allow a user to transport the multifunctional tray case 100 easily and efficiently. The handle is typically attached to the second complimentary half 106, but can be secured to any part of the multifunctional tray case 100 without affecting the overall concept of the invention. The handle is secured to the multifunctional tray case 100 via molding, fastening with hardware, welding, etc., or any other suitable securing means as is known in the art.

Further, the multifunctional tray case 100 may comprise latches 120 which act to retain the multifunctional tray case 100 in a closed position or allows it to be unlocked so that a user can manually fold the multifunctional tray case 100 into an open position. The latches 120 are typically positioned at the front of the multifunctional tray case 100 near the handle, but can be positioned on any part of the multifunctional tray case 100 without affecting the overall concept of the invention.

Additionally, the multifunctional tray case 100 comprises at least one power outlet 122 and/or light socket 124 positioned near the back of the multifunctional tray case 100 near the hinges 116, but can be positioned on any part of the multifunctional tray case 100 without affecting the overall concept of the invention. Typically, the multifunctional tray case 100 comprises a plurality of power outlets 122, but any number of power outlets 122 can be provided without affecting the overall concept of the invention. Further, at least one light socket 124 can also be provided, the at least one light socket 124 is typically a fluorescent light socket, but can be any other suitable light socket as is known in the art. Furthermore, the power outlets 122 and light socket 124 are powered by and in electrical communication with an external power source. Specifically, the multifunctional tray case 100 comprises an external power cord 126 in electrical communication with the power outlets 122 and light socket 124. The external power cord 126 plugs into a wall receptacle (not shown) or other power source to power the power outlets 122 and light socket 124. The multifunctional tray case 100 can be powered via any suitable power source as is known in the art, and the power outlets 122 and/or light socket 124 can comprise any suitable configuration per the needs and desires of a user without affecting the overall concept of the invention.

FIGS. 3A-B illustrate the multifunctional tray case 100 pivoted in an open position with the main compartment 300 open. The multifunctional tray case 100 comprises a main compartment 300 removably secured to an interior of the first complimentary half 104. The main compartment 300 comprises a large central tray 302 which may also comprise at least one segmented tray 304 and/or other dividers formed therein. The central tray 302 and segmented tray 304 can comprise any suitable configuration per the needs and desires of a user without affecting the overall concept of the invention.

The main compartment 300 also comprises a fold-open (or flip-top) cover 306 which creates a flat surface when closed and when opened forms a shallow extension of the main compartment 300. Specifically, the cover 306 is supported by two support arms that fold out of the main compartment 300 to support the cover 306. The cover 306 may also comprise at least one thumb release 308 to allow the cover 306 to be completely removed from the main compartment 300. Further, the main compartment 300 may also comprise at least one thumb release 308 that allows the entire main compartment 300 to be removed from the multifunctional tray case 100.

Additionally, on either side of the main compartment 300, there is positioned at least one side compartment 310 secured to the main compartment 300. Preferably, there are two side compartments 310 secured to either side of the main compartment 300, but any number of side compartments 310 can be utilized depending on the needs and wants of a user, and the side compartments 310 can be positioned on any part of the main compartment 300 without affecting the overall concept of the invention. Further, the side compartments 310 comprise a fold-open (or flip-top) cover 306 which creates a flat surface when closed and when opened forms a shallow extension of the main compartment 300. The cover 306 may also comprise at least one thumb release 308 to allow the cover 306 to be completely removed from the side compartments 310.

The side compartments 310 are not necessary, and merely provide additional storage for a user. Typically, a fluorescent light assembly can be stored within one of the side compartments 310 for easy access by a user. However, the fluorescent light assembly is not necessary and any other suitable tools and other equipment and supplies can be stored within the main compartment 300 and side compartments 310 as needed by the user.

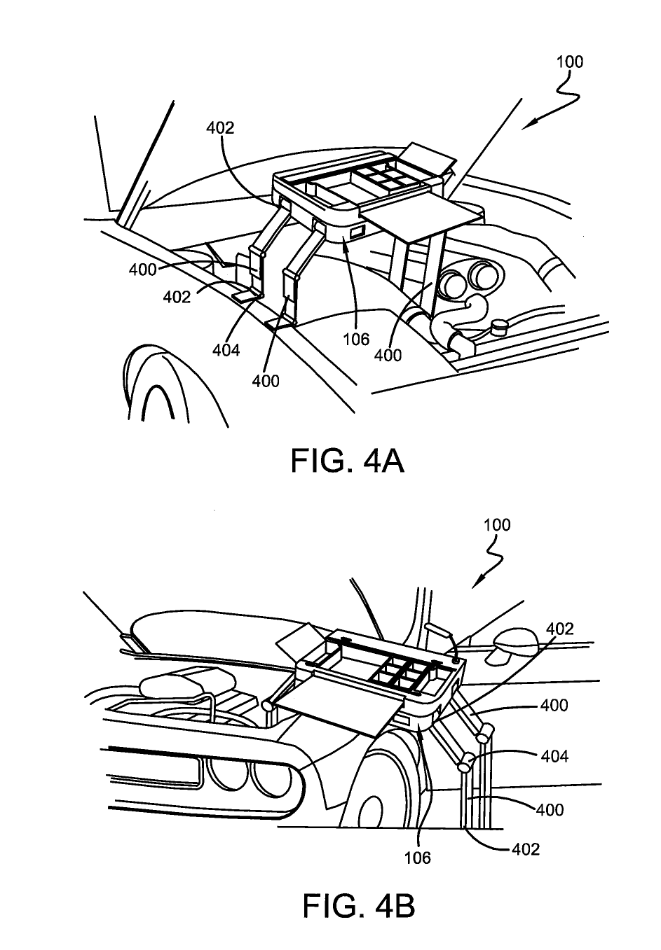

FIGS. 4A-B illustrate the multifunctional tray case 100 in use with a vehicle and utilizing legs 400. The multifunctional tray case 100 comprises at least one movable leg 400 secured to the second complimentary half 106. In a preferred embodiment, there are four movable legs 400 secured to the corners of the second complimentary half 106, but any number of legs 400 can be utilized depending on the wants and needs of a user, and the movable legs 400 can be secured to any part of the multifunctional tray case 100 without affecting the overall concept of the invention.

The movable legs 400 are typically three joint 404 leg assemblies, which fold down from all corners of the second complimentary half 106 of the multifunctional tray case 100. The movable legs 400 may be rectangular in shape, though any other suitable shape can also be used without affecting the overall concept of the invention. Typically, the movable legs 400 comprise a spring-lock style button on each joint 404 to adjust the legs 400 to the desired height individually. The main leg joints 404 secured at the multifunctional tray case 100 section release and lock via button latches on the second complimentary half 106 of the multifunctional tray case 100. However, any other suitable lock can be used to allow the legs 400 to be adjusted as is known in the art without affecting the overall concept of the invention. Through the use of the joints, the legs 400 can be adjusted such that the surface of the tray case 100 is level even across uneven terrain. Specifically, each leg can be adjusted independently of the other legs allowing the tray case 100 to be placed on an uneven surface and still be level.

Furthermore, the joints 404 of the legs 400 allow the legs 400 to be retracted upwards and folded into the second complimentary half 106 of the multifunctional tray case 100 for storage. Thus, the four movable legs 400 are stored within the interior of the second complimentary half 106 when not in use and folded down from the corners of the second complimentary half 106 when in use. The legs 400 can have any suitable number of joints 404, though typically, the legs 400 would have three joints 404, as having less than three joints would severely limit leveling ability and having more than three joints could create user difficulty and complexity toward compacting the legs 400.

The legs 400 would generally be constructed of aluminum, steel, magnesium, or a composite plastic, etc., though any other suitable material may be used to manufacture the legs 400 as is known in the art without affecting the overall concept of the invention. The legs 400 can also comprise a variety of colors and designs to suit user preference. The legs 400 are approximately between 16 and 20 inches long as measured from opposing ends 402 when fully extended.

Additionally, the legs 400 may comprise leg extensions (not shown) which allow each leg 400 to be further extended. The leg extensions are secured to the four movable legs 400 and can be stored within the interior of the second complimentary half 106 along with the legs 400 when not in use. Typically, the leg extensions can attach and/or be removed from the foot portion (or bottom portion) of the legs. The leg extensions would generally be constructed of aluminum, steel, magnesium, or a composite plastic, etc., though any other suitable material may be used to manufacture the leg extensions as is known in the art without affecting the overall concept of the invention. The leg extensions can also comprise rubber feet to protect surfaces that the multifunctional tray case 100 is placed on. The leg extensions can also comprise a variety of colors and designs to suit user preference.

The leg extensions are approximately between 12 and 16 inches long as measured from opposing ends when fully extended. Further, the legs 400 and leg extensions can be constructed from or coated with a surface protecting coating or material to prevent damage to delicate surfaces, such as high density urethane, rubber, nylon, etc., or any other suitable material as is known in the art without affecting the overall concept of the invention.

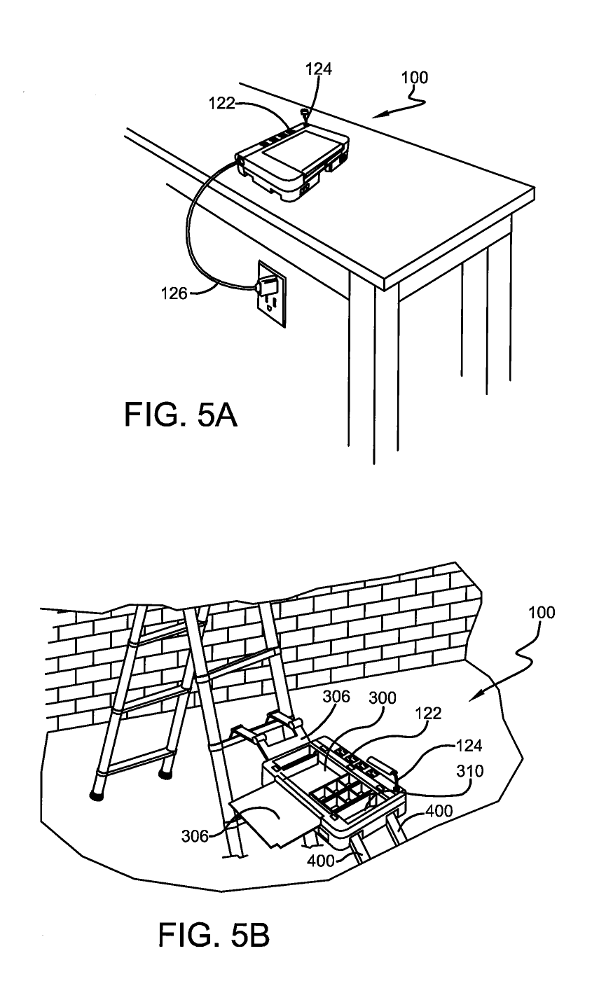

FIGS. 5A-B illustrate the multifunctional tray case 100 in use. Specifically, FIG. 5A illustrates the multifunctional tray case 100 in use as a work desk and FIG. 5B illustrates the multifunctional tray case 100 in use as a work tool supported against a ladder. In operation, a user (not shown) would choose the color and/or specific design of the multifunctional tray case 100 that meets their needs and/or wants. The user would then unlatch and open the multifunctional tray case 100, manually pivoting the first 104 and second 106 complimentary halves approximately 180 degrees, such that the case 100 completely inverts upon itself.

If desired, the user would then un-fold the legs 400 from the interior of the second complimentary half 106 of the multifunctional tray case 100 and would position the legs 400 in the desired position and/or utilize the leg extensions if necessary. Specifically, each joint on the legs 400 would include a locking button which allows the leg joints to pivot into the desired position. When using the multifunctional tray case 100 as a work desk, a user need not un-fold the legs 400 from being stored within the second complimentary half 106 of the multifunctional tray case 100. The multifunctional tray case 100 is then positioned as desired by the user either directly on the work surface or stood on its legs 400 (and/or leg extensions).

Once in position, the cover 306 of the main compartment 300 is then opened and removed if necessary. The covers 306 of the side compartments 310 are then opened and removed if necessary. The user is then able to access the interior tool tray(s) and segmented areas of the main compartment 300 and side compartments 310, and can store and remove tools and other supplies as needed when performing the project at hand. The user can also utilize the external power cord 126 of the multifunctional tray case 100.

Further, the user can plug in the external power cord 126 to an existing electrical outlet or other power source, allowing the user access to the power outlets 122 and light sockets 124 of the multifunctional tray case 100. The user then has access to power and light as needed. Thus, mechanics, campers, writers, artists, and business people, etc., would appreciate the ability to customize the multifunctional tray case 100 to carry tools of their respective trades while offering unparalleled organization and portability. Anyone who uses this invention would benefit from the convenience and organization this multifunctional tray case 100 provides.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multifunctional tray case, comprising:
a box-like structure comprised of first and second complimentary halves, each half comprising a top surface and a bottom surface, a pair of end walls, and a pair of side panels; and
wherein the pair of end walls and the pair of side panels are substantially identical in height; and
a hinge securing the first and second complimentary halves together at one of the pair of side panels, wherein the hinge allows the first and second complimentary halves to pivot from a closed position, approximately 180 degrees to an open position; wherein the open position allows the top surface of the first complimentary half to contact the bottom surface of the second complimentary half.

2. The multifunctional tray case of claim 1, further comprising a main compartment removably secured to an interior of the first complimentary half.

3. The multifunctional tray case of claim 2, wherein the main compartment comprises at least one segmented tray formed therein.

4. The multifunctional tray case of claim 3, wherein the main compartment comprises a fold-open cover.

5. The multifunctional tray case of claim 4, further comprising at least one side compartment secured to the main compartment.

6. The multifunctional tray case of claim 5, wherein the at least one side compartment comprises a fold-open cover.

7. The multifunctional tray case of claim 1, further comprising four movable legs with joints which are secured to corners of the second complimentary half.

8. The multifunctional tray case of claim 7, wherein the four movable legs are stored within an interior of the second complimentary half when not in use and folded down from the corners of the second complimentary half when in use.

9. The multifunctional tray case of claim 8, wherein the four movable legs each comprise a spring-lock button on each joint to adjust the four movable legs to a desired height individually.

10. The multifunctional tray case of claim 9, comprising four leg extensions secured to the four movable legs.

11. The multifunctional tray case of claim 2, further comprising at least one power outlet secured to the main compartment.

12. A multifunctional tray case, comprising:
a box-like structure comprised of first and second complimentary halves, each half comprising a top surface and a bottom surface, a pair of end walls, and a pair of side panels; and
wherein the pair of end walls and the pair of side panels are substantially identical in height;
a main compartment removably secured to an interior of the first complimentary half and comprising at least one segmented tray formed therein;
at least one side compartment secured to the main compartment; and
a hinge securing the first and second complimentary halves together at one of the pair of side panels, wherein the hinge allows the first and second complimentary halves to pivot from a closed position, approximately 180 degrees to an open position; wherein the open position allows the top surface of the first complimentary half to contact the bottom surface of the second complimentary half.

13. The multifunctional tray case of claim 12, wherein the main compartment and the at least one side compartment comprises separate fold-open covers.

14. The multifunctional tray case of claim 12, further comprising four movable legs with joints which are secured to corners of the second complimentary half.

15. The multifunctional tray case of claim 14, wherein the four movable legs are stored within an interior of the second complimentary half when not in use and folded down from the corners of the second complimentary half when in use.

16. The multifunctional tray case of claim 15, wherein the four movable legs each comprise a spring-lock button on each joint to adjust the four movable legs to a desired height individually.

17. The multifunctional tray case of claim 16, further comprising four leg extensions secured to the four movable legs.

18. The multifunctional tray case of claim 17, further comprising at least one power outlet secured to the main compartment.

19. A multifunctional tray case, comprising:
a rectangular box-like structure comprised of first and second complimentary halves, each half comprising a top surface and a bottom surface, a pair of end walls, and a pair of side panels; and
wherein the pair of end walls and the pair of side panels are substantially identical in height;
a main compartment removably secured to an interior of the first complimentary half and comprising at least one segmented tray formed therein;
at least one side compartment secured to the main compartment;
a hinge securing the first and second complimentary halves together at one of the pair of side panels, wherein the hinge allows the first and second complimentary halves to pivot from a closed position, approximately 180 degrees to an open position; wherein the open position allows the top surface of the first complimentary half to contact the bottom surface of the second complimentary half; and
four movable legs with joints which are secured to corners of the second complimentary half, wherein the four movable legs are stored within interior of the second complimentary half when not in use and folded down from the corners of the second complimentary half when in use.

20. The multifunctional tray case of claim 19, further comprising at least one power outlet secured to the main compartment.
